(19) United States
(12) Patent Application Publication
(10) Pub. No.: US 2009/0005489 A1
(43) Pub. Date: Jan. 1, 2009

(54) NANOCLAY FILLED FLUOROPOLYMER DISPERSIONS AND METHOD OF FORMING SAME

(75) Inventors: Robert C. Daly, Greece, NY (US); David J. Arthur, Norwood, MA (US); F. Douglas Kelley, Webster, NY (US); Michael Duffy, Rochester, NY (US)

Correspondence Address: BASCH & NICKERSON LLP, 1777 PENFIELD ROAD, PENFIELD, NY, 14526, US

(73) Assignee: NaturalNano Research, Inc., Pittsford, NY (US)

(21) Appl. No.: 12/145,525

(22) Filed: Jun. 25, 2008

Related U.S. Application Data
(60) Provisional application No. 60/946,194, filed on Jun. 26, 2007.

(51) Int. Cl. C09D 127/12; C08K 3/34; C09D 127/20; C09D 127/18; C09D 127/16; B05D 3/02; B05D 1/18; B05D 1/02; B05D 3/00

(52) U.S. Cl. 524/446; 427/372.2; 427/430.1; 427/427; 427/299

(57) ABSTRACT

Disclosed herein is an aqueous dispersion and a method for making said dispersion, and more particularly, a dispersion that comprises a nanoclay such as a tubular clay (e.g. halloysite), a fluoropolymer and the requisite surfactants for dispersion stability. In various embodiments, and applications thereof to substrates and the like, the dispersion improves the manufacturability of articles that include coating fluoropolymer dispersions while retaining the unique properties of the fluoropolymer coating.

This application clams priority under 35 USC 119(e) from U.S. Provisional Patent Application 60/946,194 for “NANOCLAY FILLED FLUOROPOLYMER DISPERSIONS AND METHOD OF FORMING SAME,” filed Jun. 26, 2007.

Disclosed herein are an aqueous dispersion and a method for making said dispersion, and more particularly, a dispersion that comprises a nanoclay such as a tubular clay (e.g. halloysite), a fluoropolymer and the requisite surfactants for dispersion stability. In various embodiments, the dispersion improves the manufacturability of articles made by coating fluoropolymer dispersions while retaining the unique properties of the fluoropolymer coating.

### BACKGROUND AND SUMMARY

A fluoropolymer dispersion is an aqueous based form of fluoropolymer produced by the emulsion polymerization of fluorinated monomers and typically used for coating metal, plastic and glass cloth, although other materials may also be coated. These dispersions are produced and sold on a global basis by several manufacturers. The following represents a composition typical of fluoropolymer dispersions as supplied by fluoropolymer manufacturers (Guide to Safe Handling of Fluoropolymer Dispersions, Fluoropolymer Manuf. Group, October 2001):

| Ingredient | Approximate Weight (% wt) |
|---|---|
| Fluoropolymer | 20-60 |
| Water | 30-70 |
| Non-ionic Surfactant | <6 |
| Fluoropolymer Polymerization Aid | <1 |

Nanoclay filled fluoropolymer dispersions of high utility can be produced by a process including:
1) preparing a dilute dispersion of nanoclay particles in surfactant/water solution;
2) concentrating the nanoclay dispersion to form a “nanoclay paste”;
3) adding the nanoclay paste to the appropriate amount of fluoropolymer dispersion, resulting in a highly filled fluoropolymer dispersion (“nanoclay/fluoropolymer concentrate”) with good dispersion stability;
4) adding additional water and/or fluoropolymer dispersion to the nanoclay/fluoropolymer concentrate to achieve the desired solids content for the dispersion and also the desired nanoclay/fluoropolymer ratio; and
5) (optionally) adding processing aids, performance aids, other fillers and/or colorants to achieve the desired nanoclay filled fluoropolymer coating formulation.

Alternatively, the nanoclay filled fluoropolymer dispersion can be produced by a process including:
1A) introducing the nanoclay into an operating extruder system (single or twin screw) at a calibrated rate and adding a solution of surfactant in water at a calibrated rate into a second port
1B) after mixing down the length of the extruder barrel, the resulting wet nanoclay paste is dropped into a stirring fluoropolymer dispersion to achieve the desired solids content for the nanoclay/fluoropolymer concentrate at the correct ratio of components; and
2) (optionally) adding additional water and/or fluoropolymer dispersion to the stirred nanoclay/fluoropolymer concentrate to achieve the desired solids content for the dispersion and also the desired nanoclay/fluoropolymer ratio; and
3) (optionally) adding processing aids, performance aids, other fillers and/or

colorants to achieve the desired nanoclay filled fluoropolymer coating formulation. Adding a surfactant to the water in this extruder method for preparing the nanoclay paste dispersion is a preferred method but with some fluoropolymer dispersions it may be possible to use water alone. If desired, the paste output from the extruder may be collected rather than added directly to the fluoropolymer dispersion. If collected, the paste is stored in a sealed container and then added in a metered fashion to the stirred fluoropolymer dispersion.

Also, alternatively, for dispersions with very high solids, the extruder production method above can be used to add a fluoropolymer dispersion at the second feed port rather than water or surfactant in water. In such a process, it may be necessary to increase the surfactant level in the fluoropolymer dispersion but otherwise the process is the same as described above.

Fluoropolymers are high-performance materials with many end uses including; architectural fabrics, membranes, wire insulation, protective coatings, solvent and corrosive resistant liners, electrical components such as circuit boards and modules water-proof/breathable apparel and non-stick cookware. Frequently, a dispersion is the best route to preparing these articles since it is conducive to conventional coating technologies. Moreover, various techniques and processes may be employed to apply the dispersion as a coating or use it as part of a composition.

However, a limitation of the fluoropolymer dispersions is that they can only be coated in very thin layers. This requires that several layers must be coated and processed in order to obtain a workable coating thickness. Each layer must be coated, dried and coalesced to the final hard coat before the next layer may be applied. One major factor demanding the thin layers is cracking during drying. The cracking takes two forms; typical random “mud cracking” and parallel straight cracks oriented in the coating direction. The cracks are possibly due to the low cohesive strength of the material as it dries and therefore contracts

Further, the cost of articles coated with fluoropolymer dispersions is high because the cost of fluoropolymers is high relative to competing materials. Thus, methods for improving the efficiency of fluoropolymer coating processes are potentially valuable if they are able to produce higher coating yields or otherwise reduce the cost of producing the coatings.

Disclosed in embodiments herein are a nanoclay filled fluoropolymer dispersion produced by a method comprising: preparing a mixture of nanoclay particles and at least water and optionally a surfactant solution; and adding the mixture to a fluoropolymer dispersion to produce the nanoclay filled fluoropolymer dispersion.

Also disclosed herein is a method for producing a nanoclay filled fluoropolymer dispersion including: preparing a dispersion of nanoclay particles in a surfactant and water solution; concentrating the nanoclay dispersion to form a nanoclay paste; adding the nanoclay paste to a fluoropolymer dispersion, to produce a highly filled fluoropolymer dispersion; and adding additional constituents to achieve a desired solids content for the dispersion.

Further disclosed herein is a method of producing a nanoclay filled fluoropolymer dispersion including: introducing the nanoclay and a surfactant solution into an operating extruder system at calibrated rates; mixing the nanoclay and surfactant solution in the extruder barrel, to produce a wet nanoclay paste; and introducing the paste into a stirring fluoropolymer dispersion to achieve a desired solids content for the dispersion.

An advantage of the nanoclay/fluoropolymer dispersion is that the nanoclay strengthens the coating during drying so that the cracks do not form in coatings that are up to about 5 times as thick as the normal limit for fluoropolymer coatings. Upon baking in the normal process, the thicker coating is still intact, without cracks. This is an enormous advantage during manufacture in that it minimizes the number of coating and drying passes or cycles required to obtain a desired thickness, thereby resulting in advantages in cost, throughput and yield.

A further advantage of this dispersion is that the addition of the nanoclay, at levels up to about 45% of the solids, does not impact the performance of the fluoropolymer coating. This means that expensive fluoropolymer can be removed from the article of manufacture and replaced with much less expensive clay.

Further disclosed in embodiments herein are articles produced in accordance with the methods disclosed, including coating and other forming methods know for use with fluoropolymer dispersions. Such articles include, but are not limited to, architectural fabrics, membranes, insulation, solvent and corrosive resistant liners, electrical components such as circuit boards and modules, water-proof/breathable apparel and various products having coatings that incorporate the dispersion (e.g., non-stick cookware).

### BRIEF DESCRIPTION OF THE DRAWING

FIG. 1 and FIG. 2 are exemplary flow-charts depicting various aspects of the disclosed processes for producing nanoclay filled fluoropolymer dispersions.

The various embodiments described herein are not intended to limit the invention to those embodiments described. On the contrary, the intent is to cover all alternatives, modifications, and equivalents as may be included within the spirit and scope of the disclosure and appended claims.

### DETAILED DESCRIPTION

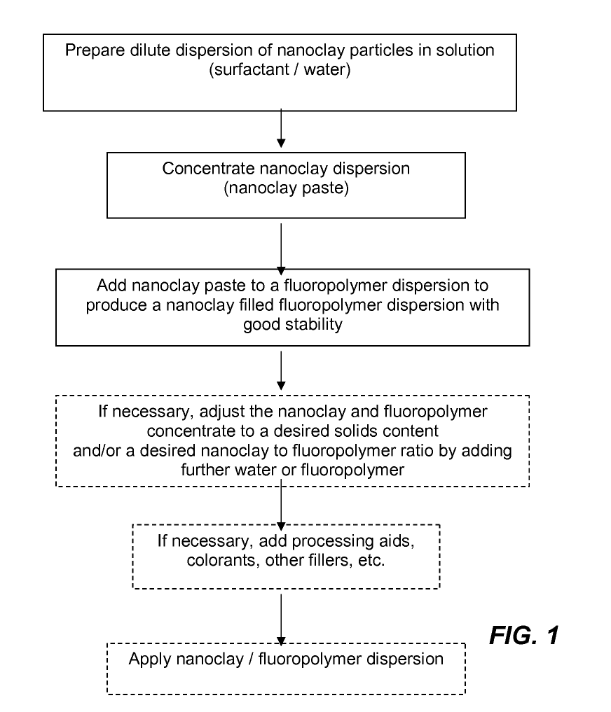

As more particularly set forth below, the disclosed materials and methods are directed to preparation of a nanoclay filled fluoropolymer dispersions having high utility. Such dispersions, can be produced by a process or method such as that depicted generally in the flowchart of FIG. 1, including:
1) preparing a dilute dispersion of nanoclay particles in surfactant/water solution;
2) concentrating the nanoclay dispersion to form a “nanoclay paste”;
3) adding the nanoclay paste to the appropriate amount of fluoropolymer dispersion, resulting in a highly filled (about 40-70% solids) fluoropolymer dispersion (“nanoclay/fluoropolymer concentrate”) with good dispersion stability;
4) adding additional water and/or fluoropolymer dispersion to the nanoclay and fluoropolymer concentrate to achieve the desired solids content for the dispersion and also the desired nanoclay/fluoropolymer ratio; and
5) adding processing aids and/or colorants to achieve the desired “nanoclay filled fluoropolymer coating formulation.
   Although disclosed herein with respect to specific steps in the process or method, it may be possible to achieve a desirable dispersion using fewer steps, additional steps, and/or slightly modified steps.

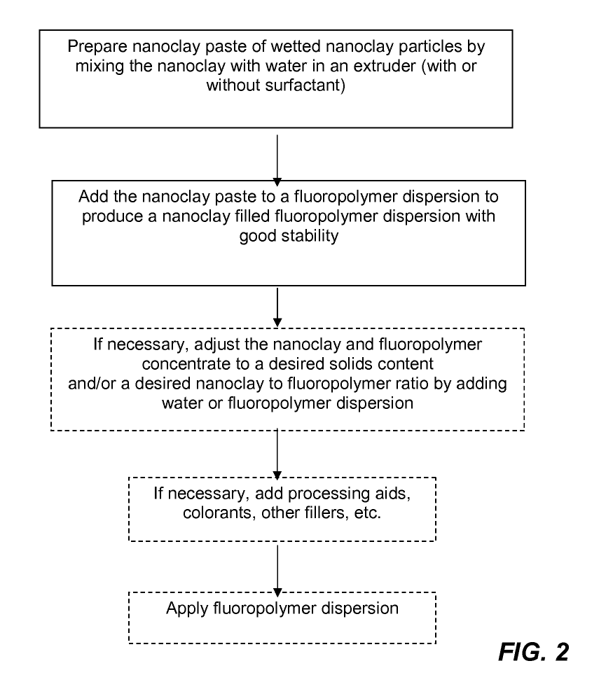

Alternatively, the nanoclay filled fluoropolymer dispersion can be produced by a process, depicted in FIG. 2, that first produces a nanoclay paste and then introduces the fluoropolymer, including:
1A) introducing the nanoclay into an operating extruder system (single or twin screw) at a calibrated rate and adding a solution of surfactant in water at a calibrated rate into a second port;
1B) after mixing down the length of the extruder barrel, the resulting wet nanoclay paste is dropped into a stirring fluoropolymer dispersion to achieve the desired solids content for the nanoclay/fluoropolymer concentrate at the correct ratio of components; and
2) (optionally) adding additional water and/or fluoropolymer dispersion to the stirred nanoclay/fluoropolymer concentrate to achieve the desired solids content for the dispersion and also the desired nanoclay/fluoropolymer ratio; and
3) (optionally) adding processing aids, performance aids and/or colorants to achieve the desired nanoclay filled fluoropolymer coating formulation.

Fluoropolymers are a class of polymers with unique physical properties including the ability to function at high temperatures. They can withstand most solvents and harsh chemical environments. They are also known for their “non-stick” properties. However, these strengths have also made them difficult to fabricate. Depending on the specific structure, the fluoropolymers may be available in pellets, powder or an aqueous dispersed form. The aqueous dispersed form of a fluoropolymer is prepared by the emulsion polymerization of the appropriate monomer or co-monomers. The emulsion polymerization of fluorinated olefins requires a fluorinated surfactant, a fluoropolymer polymerization aid (FPA), to allow the formation of a controlled and stable dispersion of the monomer prior to initiation. Examples of FPA's are the sodium and ammonium salts of perflouorooctanoic or nonanoic acids. Typically, fluoropolymers synthesized by an emulsion process are formulated for use as dispersions by adding further surfactant and concentrating the dispersion. The additional surfactant may be the same one used in the polymerization or a different one. Commonly the surfactant is a nonionic polyether. Most commonly, the surfactant is an alkylphenol alkoxylate such as Triton X-100. The stabilized dispersion may be concentrated by methods such as centrifugation, electrodecantation, evaporation or thermal concentration.

Readily available fluoropolymer dispersions include PTFE (polytetrafluoroethylene), PFA (copolymers of tetrafluoroethylene with perfluoroalkoxy side groups), FEP (copolymers of tetrafluoroethylene with hexafluoropropylene), MFA (copolymers of tetrafluoroethylene with perfluoromethyl vinyl ether), PVDF (polyvinylidene fluoride), fluorinated copolymers of vinylidene fluoride, etc. These fluoropolymer dispersions are typically in the range of about 25-65% solids and are stabilized with a nonionic surfactant. It is believed preferable to use fluoropolymer dispersions with higher solids content (60%) and high surfactant content (less than about 6%). The resulting fluoropolymer dispersion has a pH between about 2 and 10, and is a milky white liquid. Additives, coating aids, colorants and fillers can also be added to the stabilized fluoropolymer dispersion at this stage.

Nanoclay compositions may include platy clays and tubular clays such as halloysite. (Halloysite nanotubes, HNT™ available from NaturalNano, Inc.), etc. A reason to prefer halloysite with fluoropolymers is that the effective particle density is very close to that of the fluoropolymer particles (approximately 2.13 g/cc) and the equivalent spherical diameter (based on expected drag resistance) is also very similar to the PTFE particles (approximately 0.32 μm). This would suggest that HNT filled fluoropolymer dispersions may be mixed uniformly on the nanoscale and should be fairly stable to resist sedimentation. The former is a quality advantage for the coating dispersion formulator and the latter is a manufacturability advantage for the coater.

Clay is a generalized term for a broad array of minerals identified as hydrous aluminum phyllosilicates, which may have small amounts of impurities such as iron, magnesium, sodium, calcium, potassium, etc. Clays are produced by weathering other minerals such as feldspar and by low temperature hydrothermal processes. The general structure of clay minerals is a two dimensional sheet containing one or more layers of SiO₄ tetrahedra and one or more layers of AlO(OH)₂ octahedra with a degree of oxygen sharing between the layers. A nanoclay is simply one of these materials which has been manipulated such that its particles are nanometer sized in one or more dimensions.

Major group classifications of clays include kaolin, smectite and illite. Most clay minerals exist in a particulate form where the sheets are stacked like a deck of cards. A platy clay means a layered or sheet-like inorganic clay material, such as a smectite or kaolinite clay in the form of a plurality of adjacent bound layers or sheets in a single clay particle, where each layer or sheet has both faces and edges, and where the vast majority of the individual clay layers or sheets terminate on the outer surface of the clay particle.

There are however, clay materials where the individual sheets are rolled into tube or scroll form rather than stacking flat. The tubes may be single wall or multiwall. The interior of the tube is called a lumen. Examples of this kind of tubular clay include halloysite, imogolite, cylindrite, and boulongerite. For clays like halloysite and imogolite, the sheet consists of an alumina face tied to a silica face. When the mineral is formed, one face will become the interior of the tube while the other will be the exterior.

Halloysite is one of the members of the kaolin clay group. Its tubes range in length from about 100 nm to 10,000 nm (10 microns), with a typical size of between 1,000 and 5,000 nm depending on the natural source. In one embodiment, the nanocomposite material includes halloysite nanoparticles having a cylindrical length of about 100 nm to about 6,000 nm, with an average of approximately 1,200 nm. Inner diameters of halloysite nanotubes range from about 10 nm up to about 200 nm with an average of approximately 40 nm, while outer diameters range from about 20 nm to about 500 nm with an average of approximately 100 nm. In one embodiment, the nanocomposite material includes halloysite nanoparticles having an average outer cylindrical diameter of less than about 500 nm. It is also possible to characterize the halloysite nanotubes using a relationship between certain dimensions, i.e., an aspect ratio, e.g., length divided by diameter. In one embodiment it is believed that halloysite nanotubes may exhibit a length/diameter ratio of between about 0.2 and 250, with an average aspect ratio of about 12.

Halloysite itself may produce stable aqueous dispersions, but the use of a surfactant may produce desirable improvements. The halloysite can be treated with cationic surfactants or reacted with various organosilanes to produce a surface that is interactive with the polymer binder and has the potential to improve the performance of the coating. Surfactants, particularly nonionic surfactants, can be added to water to improve the ability of halloysite to disperse in water. For this application, the treatment or the surfactants should not, of course, negatively impact the stability of the fluoropolymer dispersion.

In an alternative embodiment, platy clays may also be employed in the fluoropolymer dispersions. Provided that it is possible to exfoliate platy clays using, for example, high shear mixing in an aqueous medium, then the use of platy clays (or combinations of HNT and platy clays) may be possible as well. It is necessary to make sure that all, or nearly all, of the high shear mixing is complete before the concentrate is formed with the fluoropolymer dispersion.

Surfactant compositions may include anionic, cationic and nonionic surfactants, but nonionic surfactants are believed preferable, to ensure compatibility with the fluoropolymer dispersion, which typically is stabilized with nonionic surfactants (e.g., Triton X-100).

In some methods of dispersion preparation, a dilute nanoclay dispersion is made. The dilute nanoclay dispersion will typically be in the range of about 1-10% solids, with about 5% being a reasonable choice, from a dispersability and productivity standpoint.

The dilute nanoclay dispersion can be converted into a nanoclay paste (about 30-70% solids, although various ranges including about 40-70% and 30-50% are also contemplated) using centrifugation and/or another suitable de-watering technique such as those mentioned above. It should be appreciated that various techniques may have their particular advantages and may be selected based upon the desired level of solids to which the dispersion is to concentrated. The concentrating step is important to enable a highly filled fluoropolymer concentrate to be made. This concentrate will typically contain greater than about 30% solids, with greater than about 50% solids being preferred. The nanoclay will also typically represent greater than about 50% of the total solids. This allows for the greatest formulation flexibility for the coating formulator. If desired, the final concentrations and ratios of components can be adjusted by adding water or fluoropolymer dispersion.

When an extruder is used to prepare the paste, the same nanoclay concentrations can be achieved in the paste (about 30-80% solids). The nanoclay/fluoropolymer concentrate is obtained by adding paste from the extruder to a fluoropolymer dispersion with up to 60% polymer solids. The exact concentration of the completed dispersion desired is dependent upon the materials used and the application, but it is typically over 30% total solids and more preferably greater than 50% solids with 60% total solids being possible. Of the solids, the nanoclay is typically about or greater than 50% of the solid concentration. If desired, the final concentrations and ratios of components can be adjusted by adding water or fluoropolymer dispersion to the higher concentration dispersion made initially.

The resulting nanoclay filled fluoropolymer dispersion coating formulation can be coated onto a substrate to form a film or coating, which may include strippable coatings and films. Coating application methods, to coat objects, include dip coating, spin coating, spraying, flow coating, slot die coating, gravure coating, reverse roll coating, knife over roll coating, rod coating, curtain coating and several other wet coating application methods. When a fiber or woven object is being coated, the process is sometimes called impregnation. If the surface that is coated has been prepared to minimize adhesion, the nanoclay/fluoropolymer coating may be striped off to produce a free standing nanoclay/fluoropolymer film.

Substrates include high temperature materials such as glass, ceramic, metals, plastics, carbon, etc. in the form of woven and non-woven fabrics, continuous films, belts, plates, wafers, and a wide variety of surfaces and three-dimensional shapes (e.g. curved surfaces and/or molded or machined components). Substrate preparation is often necessary when coating fluoropolymer dispersions. Both chemical etching or physical roughening are used and at times primer coatings must be applied before the nanoclay filled fluoropolymer dispersion can wet and coat properly.

After the coating formulation is applied to the substrate, the water phase is typically removed by drying, the surfactant(s) and processing aids are typically removed by baking at temperatures between about 250° C. and 280° C., and the fluoropolymer binder continuous phase is typically formed or sintered by heating above the melting point of the fluoropolymer. Sintering temperatures can be in the range of 450° C. All three of these process steps may be accomplished in multi-zone continuous dryer(s)/oven(s). The coating, drying, baking and sintering cycle can be repeated several times, in seriatim, to produce thick coatings made up of multiple thin layers.

A large advantage of the halloysite/fluoropolymer composite comes during coating and thermal processing of the coating. Due to the reinforcement of the tubular halloysite clay during the drying process, the applied coatings are much less likely to crack as they go through the drying, baking and sintering processes required to produce robust fluoropolymer composite coatings. A cracked coating does not recover to a good coating during further thermal processes so the coating, or part which is being coated, is defective if cracking develops during drying. The halloysite/fluoropolymer dispersion allows thicker coatings to be made without cracks and with low defect levels. The workable coating thickness limits for fluoropolymer dispersions depend on the polymer, the dispersion concentration and the drying process, but range from 0.4 to 0.8 mils (i.e., 0.0004-0.0008 inches) of dry coverage. With the halloysite/fluoropolymer composite useful crack free coating thicknesses range from 1.0 to 2.8 mils. Specifically, for a PTFE dispersion which was previously limited to a coating thickness of near 0.7 mil, the halloysite/PTFE dispersion allowed crack free coating up to 1.2 mil. Being able to coat and sinter at least at about 1.0 mil, and even at about 1.2 mil, more than twice the normal thickness, eliminates several coating steps and produces a defect free product at much higher throughput.

The final articles are typically either a free-standing nanoclay filled fluoropolymer film (after releasing from a substrate) or a coated substrate (e.g., coated glass fabric). Articles are produced in accordance with the methods disclosed, including coating and other forming methods know for use with fluoropolymer dispersions. Such articles include, but are not limited to, architectural fabrics, membranes, insulation, solvent and corrosive resistant liners, electrical components such as circuit boards and modules, water-proof/breathable apparel and various products having coatings that incorporate the dispersion (e.g., non-stick cookware).

The resulting nanoclay filled fluoropolymer films or coatings have essentially the same physical performance as the fluoropolymer films yet contain far less fluoropolymer in a given thickness of coating. Small improvements are noted for the physical properties of these nanoclay/fluoropolymer composite coatings for properties such as abrasion and wear resistance, thermal expansion coefficient and creep resistance. But, the major advantage of the nanoclay filled fluoropolymer films and coatings is that the performance of a fluoropolymer film or coating can be obtained using much less fluoropolymer. Since the fluoropolymer is much more expensive than the nanoclay, the result is similar physical performance at a much lower price. Crack free coatings containing nanoclay at between about 20 and 60% of the total dry solids, preferably between about 30 and 55% of the total dry solids are a considerable cost advantage.

Inclusion of these large amounts of nanoclay (e.g., greater than about 25% and preferably about 40%), can also enable reactions and interactions that are not possible with the consolidated fluoropolymer itself, since significant amounts of nanoclay will be at or near the surface. Altered surface conditions can improve wetability and adhesion to materials which have been incompatible over or under fluoropolymer layers previously. The potential to dye the nanoclay within the composite also leads to the possibility of various stable colors for fluoropolymer coatings. Moreover, further contemplated is the possibility that if the nanoclay tubules protrude from the consolidated coating they may serve to “stitch” the layers together more completely to prevent delamination of the coating layers.

The external surface of the tubular clay filler can interact with the other components of the composite in the normal manner of a clay surface. However, the tubular interior may be filled with an additional component. The interior volume of the tube, referred to as the lumen, provides a unique space. A small molecule contained within the lumen could have dramatically different availability than the same material within the bulk of the composite. This use of the clay tubes as a location for an eluent is described in U.S. Pat. No. 5,651,976 by Price et al., which is hereby incorporated by reference in its entirety. The lumen of the clay nanotubes could be leveraged to facilitate release of the material over time or a release during an event like heating. Tubular clay particles may provide the opportunity to introduce other chemistries into the fluoropolymer coating as they undergo thermal processing or in final applications.

The nanoclay filled fluoropolymer concentrate is expected to be a preferred product form for coating formulators to work with, as the nanoclay is already pre-dispersed into the fluoropolymer dispersion (convenience and quality) and the customer does not have to handle nanoscale powders (addresses health and safety concerns). In an alternative process, the initial nanoclay dispersion can be made directly to a final use concentration and combined with the correspondingly prepared fluoropolymer dispersion if this is advantageous. In other words, once one was making a specific more dilute composition, it may be possible to make it directly rather than going through a concentration step. For lower nanoclay/fluoropolymer ratios, it may not be necessary to concentrate the nanoclay dispersion all the way to a paste, or at all. In the example disclosed below, nanoclay dispersions were prepared at approximately 5% solids and then concentrated to paste at greater than about 50% solids. However, for a lower nanoclay/fluoropolymer ratio case, it may be possible to prepare a nanoclay dispersion at about 20% solids and add it directly to the fluoropolymer dispersion.

As another example, one could conceivably add dry nanoclay powder directly to a fluoropolymer dispersion, but the method of simply adding dry fillers to a fluoropolymer dispersion using low shear mixing is often not successful. It is even more difficult to achieve good dispersion at nanoscale levels with the nanoclays without using high shear mixing, and the fluoropolymer dispersions cannot tolerate high shear mixing as the fluoropolymer dispersion itself will become unstable. Accordingly, while it may be possible to make direct additions of dry additives, the proposed method produces satisfactory results without subjecting the fluoropolymer dispersion to high shear. When an extrusion system is used for direct mixing, the screw design and revolution rates must be controlled to protect the fluoropolymer dispersion.

Additionally, beyond health and safety considerations, there is a significant advantage of the method described for producing a paste over the traditional process of simply adding nanoclay powders directly to the fluoropolymer dispersion. This is due to the fact that the fluoropolymer dispersion can easily be destabilized during high shear mixing (coagulation or flocculation) or the clay can compete with the fluoropolymer for surfactants. However, to prepare a good dispersion of nanoclay in water, it is important to use high shear mixing, screw mixing, ball milling or sonication to break up agglomerates. The proposed methods ensure that nanoclay agglomerates will be broken down to primary particles and that each particle will be uniformly coated with surfactant.

The practice of one or more aspects of the disclosed materials and their applications are illustrated in more detail in the following non-limiting example(s), including those in which halloysite is dispersed into polymer base materials to produce nanocomposites for testing and characterization. It will be appreciated that various levels and related ranges of halloysite nanotube fillers may be employed, both approximating and between the various ranges described herein.

### EXPERIMENTAL RESULTS

A nanoclay filled fluoropolymer dispersion was prepared in accordance with the methods set forth above. The nanoclay powder was halloysite nanotubes (HNT™) obtained from NaturalNano. This HNT powder was previously air milled but was “untreated” (e.g., no quaternary ammonium salts exchange or surface treatments). The HNT was also unfilled, but it is expected that filled HNTs would also work well with the methods set forth herein. The fluoropolymer dispersion was DuPont Teflon™ TE 3859, a polytetrafluoroethylene (PTFE) dispersion containing 60% PTFE.

### Example 1

### Preparation of Nanoclay Paste by Concentration

A nanoclay dispersion was prepared at about 5% solids by slowly adding 21 g of nanoclay (HNT™ from NaturalNano, Inc.) to 400 g of 1% Triton X-100/de-ionized water solution while mixing at 5,200 RPM on a Silverson L4RT-A high shear mixer, and mixing for ½ hr. This was found to produce a uniform, dilute nanoclay dispersion that was stable to flocculation by breaking down of nanoclay aggregates into primary clay particles (using high shear mixing) and preventing nanoclay primary particles from re-agglomerating (by coating the nanoclay primary particles with nonionic surfactant to achieve steric stabilization). This dispersion was stable to flocculation, but not stable to sedimentation. Once stirring was stopped, within 24 hrs much of the nanoclay settled towards the bottom, leaving a supernatant that was noticeably lower in solids content than the sediment layer. To speed up this process, a centrifuge was used. The 5% nanoclay dispersion was added to 50 ml centrifuge tubes and centrifuged for 13 minutes at 4,370 RCF. After the cycle was complete, the supernatant was decanted, and the sediment was collected. This sediment had a paste-like consistency, with solids content of 57%. The material at this stage is referred to as a “nanoclay paste.

To confirm that nanoclay paste could be easily redispersed, a small sample of nanoclay paste was added to enough de-ionized water to bring nanoclay solids content to 28% and stirred with a spatula (i.e., relatively low shear). This 28% solids nanoclay dispersion was then tested for degree of dispersion using a “fineness of grind” gauge, with resolution down to 1 μm. No nanoclay agglomerates were observed, even at a scale of 1 μm. Since the nanoclay primary particles were expected to be approximately 0.1 μm outer diameter and 1 μm long, this suggested that the nanoclay primary particles could be re-dispersed during a dilution step at low shear. This was an important finding, as it is an intent to add the paste directly to the fluoropolymer dispersion, using the water in the fluoropolymer dispersion for dilution of the nanoclay paste. This would enable production of “nanoclay/fluoropolymer concentrate” with high solids content (ideally >50%) and high nanoclay/fluoropolymer solids ratio (ideally 50/50 or so by weight). It is well-known that fluoropolymer dispersions can be easily de-stabilized during high shear mixing (coagulation or flocculation will occur), thus, this dilution/blending step needed to be done at low shear.

### Example 2

### Preparation of Halloysite/PTFE Concentrate

To make the halloysite/PTFE concentrate, 606 g of halloysite paste (57% solids) was added to 400 g of PTFE (DUPONT Teflon™) dispersion (60% solids) and blended together for 3 hrs. using a dual squirrel cage mixer at 250 RPM. This type of mixer is typically used to mix highly pigmented paints, which resembles the consistency of the nanoclay/fluoropolymer concentrate. This mixing did a good job of redispersing the nanoclay particles in the available water for the PTFE dispersion. The resulting halloysite/fluoropolymer concentrate had about 58% solids, with about 59% of the solids being halloysite. The halloysite/fluoropolymer concentrate appeared to have a very uniform consistency (like a well-mixed paint). The viscosity was measured using a Brookfield viscometer (see Table below), and exhibited shear thinning behavior. The nanoclay/fluoropolymer concentrate also appeared very stable to sedimentation.

Viscosity

| | |
|---|---|
| 15 | cPs @ 2.5 s-1 |
| 8.7 | cPs @ 5 s-1 |
| 4.9 | cPs @ 10 s-1 |
| 2.8 | cPs @ 20 s-1 |

The density of the HNT filled PTFE mixture was also measured to be 1.377 g/cc, all measurements being made at room temperature. The dispersion concentrate thus formed could be used directly or diluted with either fluoropolymer dispersion or water or an aqueous surfactant solution to make a dispersion optimized for a particular application.

### Example 3

### Working Concentration Nanoclay/Fluoropolymer Dispersion

A working concentration dispersion was prepared by mixing 60 gm of a halloysite/PTFE concentrate which contains 60% solids; 30% halloysite and 30% PTFE with 40 gm of a 50% PTFE dispersion. Magnetic stirring produced a uniform, smooth, readily flowing dispersion which did not settle out or separate for at least several days. The total % solids of this dispersion was 56%.

### Example 4

### Coatings of the Working Concentration Halloysite/PTFE Dispersion

The working concentration halloysite/PTFE dispersion of Example 3 was coated using a plate and rod to produce a desired thickness. The rods were either wire wrapped or engraved to allow controlled wet laydown of the dispersion. A plastic sheet, either polyethylene terephthalate (PET) or polyimide (Kapton™), was mounted on the plate and the rod positioned at the top. The working dispersion was poured onto the plastic sheet in front of the bar. The bar was then pulled smoothly down the plate, leaving behind a uniform laydown of the coating fluid.

The coating was then dried using indirect hot air. The dried coating thickness was measured with a micrometer.

### Comparative Example 1

### Coating the PTFE (DUPONT Teflon™) Dispersion (60% Solids)

The original PTFE dispersion was coated and dried exactly as described for Example 4 above.

A comparison of the coatings of Example 4 and Comparative Example 1 was then made. The thicknesses of the respective coatings were measured with a micrometer and then the coatings were evaluated by and with a magnifying loupe. When cracks were observed in a coating they appeared in two different ways. Most noticeable were viewable cracks which were aligned in the direction that the coating bar was pulled and which could be quite long. Using the loupe to look closer the coating appears to curl up at the edge of the crack. The other cracks were much more subtle and non-directional; a mud cracking pattern. The coatings of Comparative Example 1 showed cracks in some coatings with a dry thickness of about 0.7 mil and all coatings of 0.8 mil thickness. The coatings of Example 4 did not show cracks at a dry coating thickness of about 1.2 mil.

Samples which had been coated on polyimide sheet could be baked and sintered at 380° C. to produce consolidated coatings. The thickest coating that did not crack during drying also did not crack during the sintering step. Coatings cracked after drying were further damaged during the heat cycle, probably due to the cracked edges curling and losing adhesion.

### Example 5

### Preparation of a Nanoclay Paste Using a Twin Screw Extruder as Mixer

A Prism Eurolab 16 twin screw extruder from Thermo Scientific was used as the extruder/mixer for preparing a nanoclay paste directly at high concentration. The screw diameter was 16 mm and the barrel length was 640 mm. The extruder screw was configured with three mixing sections. The extruder heating elements remained off during the entire process.

In the manner generally described above and depicted in FIG. 2, the halloysite was added to the extruder at the first feeder position using a k-Tron weigh feeder at a setting which delivered 15 g/min. A second feeder was positioned immediately adjacent to the first and a was fitted with a metered aqueous addition system set to deliver 14 g/min of solution. The wet feeder was charged with water. The extruder was started and brought up to 250 rpm as the feed systems were turned on. With both feeds established, the torque was only 16% of maximum. Very limited frictional heating occurred.

The output from the extruder die was a heavy paste with some strength which could maintain its strand shape. It was slightly warm to the touch. The paste was shown to be about 56% solids by calcining the paste, although it may be possible to produce pastes with solids in the range of about 40%-70%. The paste was collected and placed in a sealed container. It may also be possible to use mixtures, which may be less paste-like, but having solids in the range of at least about 25%. The amount of “dilution” of the nanoclay paste, to achieve a desired working nanoclay/fluoropolymer dispersion is therefore, a function of the solids percentage.

### Example 6

### Preparation of a Working Halloysite/PTFE Dispersion

Sixty (60 gm) of a 60% solids dispersion of PTFE (DUPONT Teflon™) was placed in a Thinky mixing cup. A small amount of surfactant (0.25 g, TX 100 from Dow) was added to 50 gm of the paste from Example 5 and mixed. The paste mixture was placed in the cup with the PTFE and the cup closed and placed in the Thinky mixer. A one minute mixing cycle was run and the cup reopened and the sample hand mixed to make sure that all of the paste had been incorporated. The cap was reclosed and another one minute mixing cycle run. The resulting heavy dispersion could be coated immediately or stored. The dispersion was stable for several days and could be revived with low shear stirring if it did separate after longer times.

### Example 7

### Coatings of Halloysite/PTFE Dispersion

A temperature controlled coating block was set at 30° C. A PET sheet was attached to the block. A 5 mil coating knife was placed at the top of the block. The halloysite/PTFE dispersion of Example 6 was poured behind the knife and the knife was then pulled down the block. The coating was covered with a lid and allowed to air dry for 30 min. The resulting coating was crack free by eye and with a loupe. The crack free coating was about 2.8 mil thick.

In view of the favorable coating thickness achieved in Example 7, it is contemplated that a single-pass coating process may be employed to produce desired thicknesses for nanoclay filled fluoropolymer films. Such a process should be able to produce consistent crack-free coatings having thicknesses of at least about 2.0 mil and more preferably about 2.8 mil as demonstrated in Example 7. It is conceivable that it may be possible to produce coatings having thicknesses greater than about 2.8 mils or about 3.0 mils as well.

The resulting nanoclay filled fluoropolymer films or coatings were observed to have similar physical performance as fluoropolymer films, yet contain far less fluoropolymer. Since the fluoropolymer is more expensive than the nanoclay, the result of the successful coatings with halloysite/PTFE dispersion is similar physical performance at a much lower price. Moreover, the ability to produce coatings with greater thicknesses further reduces the cost of production for such coatings. Crack free coatings containing nanoclay at between about 20-60% of the total dry solids, preferably between about 30-55% of the total dry solids, are therefore available at a considerable cost advantage.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A nanoclay filled fluoropolymer dispersion produced by a method comprising:
preparing a mixture of nanoclay particles and at least water; and
adding the mixture to a fluoropolymer dispersion to produce the nanoclay filled fluoropolymer dispersion.

2. The dispersion according to claim 1, wherein the mixture is produced as a nanoclay paste.

3. The dispersion according to claim 2, wherein the nanoclay paste is produced by a method comprising:
introducing the nanoclay particles into an extruder system;
adding a solution of surfactant into the extruder system; and
mixing the nanoclay particles and the surfactant solution down the length of the extruder barrel to produce a wet nanoclay paste.

4. The dispersion according to claim 1, wherein the mixture has a concentration of at least about 25% solids.

5. The dispersion according to claim 4, wherein the mixture has a concentration of at least about 40% solids.

6. The dispersion according to claim 1, wherein the mixture includes a dilute dispersion of nanoclay particles and a surfactant.

7. The dispersion according to claim 6, wherein the dilute dispersion is produced by a method comprising adding nanoclay to a surfactant and de-ionized water solution while mixing in a high shear mixer, and wherein the method further comprises concentrating and collecting nanoclay sediment from the dilute dispersion.

8. The dispersion of claim 1 wherein said nanoclay particles include tubular nanoclay particles.

9. The dispersion of claim 8, wherein said tubular nanoclay particles include halloysite to produce a halloysite filled fluoropolymer dispersion.

10. The dispersion according to claim 1, wherein the method further comprises adding additional water to achieve a desired solids content for the dispersion.

11. The dispersion according to claim 1, wherein the method further comprises adding fluoropolymer dispersion to achieve a desired nanoclay/fluoropolymer ratio.

12. The dispersion according to claim 1, wherein the method further comprises adding at least one processing aid.

13. The dispersion according to claim 1, wherein the method further comprises adding at least one colorant.

14. The dispersion according to claim 1, wherein the method further comprises:
applying the dispersion to a substrate as a coating; and
drying the coating.

15. The dispersion according to claim 1, wherein applying the dispersion to a substrate further comprises applying the dispersion in a single pass thickness to achieve a dried coating thickness of at least about 1.0 mil.

16. The dispersion according to claim 15, wherein the dried coating thickness is at least about 1.2 mil.

17. The dispersion according to claim 1, wherein applying the dispersion to a substrate further comprises applying the dispersion in a single pass thickness to achieve a dried coating thickness of at least 2.0 mil.

18. The dispersion according to claim 16, wherein the dried coating thickness is at least about 2.8 mil.

19. A coating comprising a dispersion of at least one nanoclay and at least one fluoropolymer.

20. The coating according to claim 19, wherein said nanoclay includes tubular nanoclay particles.

21. The coating according to claim 19, wherein said nanoclay includes halloysite.

22. The coating according to claim 19, wherein said coating is applied in a single pass to a substrate to achieve a dried coating thickness of at least about 1.0 mil.

23. A method for producing a nanoclay filled fluoropolymer dispersion including:
preparing a dispersion of nanoclay particles in a surfactant and water solution;
concentrating the nanoclay dispersion to form a nanoclay paste;
adding the nanoclay paste to a fluoropolymer dispersion, to produce a highly filled fluoropolymer dispersion; and
adding additional constituents to achieve a desired solids content for the dispersion.

24. The method of claim 23, further including adding at least one processing aid to the dispersion to achieve a desired nanoclay filled fluoropolymer coating formulation.

25. The method of claim 24, further including applying the nanoclay filled fluoropolymer dispersion to a substrate as a coating, and drying the coating.

26. The method of claim 22, wherein said fluoropolymer dispersion is selected from the group of fluoropolymers consisting of: PTFE (polytetrafluoroethylene), PFA (copolymers of tetrafluoroethylene with perfluoroalkoxy side groups), FEP (copolymers of tetrafluoroethylene with hexafluoropropylene), MFA (copolymers of tetrafluoroethylene with perfluoromethyl vinyl ether), PVDF (polyvinylidene fluoride), and fluorinated copolymers of vinylidene fluoride.

27. The method of claim 23, further including adding water.

28. The method of claim 23, further including adding fluoropolymer dispersion.

29. The method according to claim 23, further including adding at least one additional constituent selected from the group consisting of:
processing aids,
performance aids, and
colorants.

30. The method of claim 23, further including applying the nanoclay filled fluoropolymer dispersion to a surface as a coating, using a process selected from the group consisting of: dip coating, spin coating, spraying, flow coating, slot die coating, gravure coating, reverse roll coating, knife over roll coating, rod coating, curtain coating and other wet coating application methods.

31. The method of claim 23, further comprising pre-treating the surface to be coated.

32. The method of claim 23, further comprising at least one drying, baking and sintering operation to adhere the coating to the surface.

33. The method of claim 23, further including incorporating the nanoclay filled fluoropolymer dispersion in an article, wherein the method of inclusion is selected from the group consisting of:
coated onto a substrate to form a strippable film;
coating an object; and
impregnation of fibrous substrates.

34. A method of producing a nanoclay filled fluoropolymer dispersion including:
introducing the nanoclay and a surfactant solution into an operating extruder system at calibrated rates;
mixing the nanoclay and surfactant solution in the extruder barrel, to produce a wet nanoclay paste; and
introducing the paste into a stirring fluoropolymer dispersion to achieve a desired solids content for the dispersion.

35. The method according to claim 34, further including adding water.

36. The method according to claim 34, further including adding fluoropolymer dispersion.

37. The method according to claim 34, further including adding at least one additional constituent selected from the group consisting of:
processing aids,
performance aids, and
colorants.

38. The method according to claim 34, further including applying the nanoclay filled fluoropolymer dispersion to a surface as a coating, using a process selected from the group consisting of: dip coating, spin coating, spraying, flow coating, slot die coating, gravure coating, reverse roll coating, knife over roll coating, rod coating, curtain coating and other wet coating application methods.

39. The method according to claim 38, further comprising pre-treating the surface to be coated.

40. The method according to claim 38, further comprising at least one drying, baking and sintering operation to cause the coating to adhere to the surface.

41. The method according to claim 38, further including incorporating the nanoclay filled fluoropolymer dispersion in an article, wherein the method of inclusion is selected from the group consisting of:
coated onto a substrate to form a strippable film;
coating an object; and
impregnation of fibrous substrates.

42. The method according to claim 34, wherein said fluoropolymer dispersion is selected from the group of fluoropolymers consisting of: PTFE (polytetrafluoroethylene), PFA (copolymers of tetrafluoroethylene with perfluoroalkoxy side groups), FEP (copolymers of tetrafluoroethylene with hexafluoropropylene), MFA (copolymers of tetrafluoroethylene with perfluoromethyl vinyl ether), PVDF (polyvinylidene fluoride), and fluorinated copolymers of vinylidene fluoride.

43. A fluoropolymer coating, comprising a single-layer nanoclay filled fluoropolymer dispersion applied to a substrate at an application thickness greater than about 1.0 mil, said coating, after drying, having a thickness of at least about 1.0 mil.

44. The fluoropolymer coating of claim 43, wherein the application thickness is at least about 2.0 mil and where said coating, after drying, has a thickness of at least about 2.0 mil.

45. The dispersion according to claim 44, wherein the dried coating thickness is at least about 2.8 mil.

46. The fluoropolymer coating of claim 43, wherein said nanoclay includes tubular nanoclay particles.

47. The fluoropolymer coating of claim 45, wherein said tubular nanoclay particles include halloysite.

48. The fluoropolymer coating of claim 43, wherein said fluoropolymer dispersion is selected from the group of fluoropolymers consisting of: PTFE (polytetrafluoroethylene), PFA (copolymers of tetrafluoroethylene with perfluoroalkoxy side groups), FEP (copolymers of tetrafluoroethylene with hexafluoropropylene), MFA (copolymers of tetrafluoroethylene with perfluoromethyl vinyl ether), PVDF (polyvinylidene fluoride), and fluorinated copolymers of vinylidene fluoride.
